(19) United States
(12) Patent Application Publication
(10) Pub. No.: US 2025/0148024 A1
(43) Pub. Date: May 8, 2025

(54) INDEPENDENT CONTENT HOSTING SYSTEM

(71) Applicant: Google LLC, Mountain View, CA (US)

(72) Inventors: Tarik Ono, Vancouver (CA); Xiguo Ma, Mountain View, CA (US); Yanling Zhang, Menlo Park, CA (US); Jiewen Wu, San Francisco, CA (US); Yuanyuan Yang, Jersey City, NJ (US); Yan Zhang, San Jose, CA (US); Negin Nejati, Mountain View, CA (US); Yi Liang, Jersey City, NJ (US); Alexander Fischer, Brooklyn, NY (US)

(21) Appl. No.: 18/937,276

(22) Filed: Nov. 5, 2024

Related U.S. Application Data
(60) Provisional application No. 63/596,596, filed on Nov. 6, 2023.

(51) Int. Cl. G06F 16/951; G06F 16/9538

(52) U.S. Cl. CPC G06F 16/951; G06F 16/9538

(57) ABSTRACT

Implementations relate to a system for hosting independent content items anchored to another online resource. The independent content items are themselves online resources. Implementations also relate to enhancing search results by incorporating independent content items anchored to a resource identified in the search result page. An example method involves identifying resources to be included in search results for a query, determining that independent content items are associated with a resource, and adding an independent content item summary control to the search result for the resource. This control enables users to access an independent content feed interface for further exploration of the independent content items anchored to the resource. The search result page, enriched with these independent content item overview, is then delivered to the user's device.

### CROSS-REFERENCE TO RELATED APPLICATION

This application is a non-provisional of, and claims priority to, U.S. Provisional Patent Application No. 63/596,596, filed on Nov. 6, 2023, entitled “Independent Content Hosting System,” the disclosure of which is incorporated by reference herein in its entirety.

### BACKGROUND

Some webpages enable a user to leave comments or reviews. These comments or reviews are often associated with an entity (e.g., an entity in a knowledge or fact repository, an item catalog, or other entity database) and are maintained by the system that hosts the webpage.

### SUMMARY

Implementations relate to a system that hosts independent content that is linked to online resources. The independent content items are themselves online resources, which can be navigated to via a browser address bar and crawled by search engines. The hosting system (publisher) may display independent content items by creator (e.g., independent content items created by the same user regardless of which resource the content items are associated with). The hosting system may display independent content items by resource (e.g., independent content items that are associated with the same resource). In some implementations, an independent content item can be provided in a search result page as a search result that is responsive to the query. Put another way, the independent content item can be responsive to a query independently of any other resource, including the resource it is associated with (anchored to). In some implementations, the search result page may treat independent content items that are responsive to a query as a separate type of result. In some implementations, independent content items linked to a resource that is responsive to a query can be provided in a search result page as part of a search result for that resource. In some implementations, an independent content summary control may be added to the search result for that resource.

Implementations include user interfaces for adding new independent content items. When a new independent content item is created it is linked to another resource and a resource locator (e.g., a URL) is generated for the independent content item. Thus, although an independent content item is linked to a resource, it is independent of that resource and is not hosted or otherwise affiliated with that resource. Because the independent content item has its own unique resource locator, it can be crawled and indexed. Some implementations include a real-time indexing pipeline that can add a new independent content item to an independent content index and/or to a search index in real time, i.e., in response to a user posting the independent content item or otherwise submitting the independent content item. This makes the independent content item available to a search system responding to queries. Because independent content items represent a unique type of resource, implementations may include new ranking signals and/or a novel ranking method that uses generative models (e.g., large language models, large vision models, etc.) to help determine the order in which to display independent content items in an independent content feed. One of the ranking signals can be a content creator score. The content creator score can also be determined by a novel ranking model based on independent content items the creator has generated. In some implementations, the system may proactively suggest creation of an independent content item. Such a proactive suggestion may, if selected, open an independent content user interface for creating a new independent content item.

The details of one or more implementations are set forth in the accompanying drawings and the description below. Other features will be apparent from the description and drawings, and from the claims.

### BRIEF DESCRIPTION OF THE DRAWINGS

FIGS. 1A and 1B illustrate an example search result with an independent content item summary control, according to disclosed implementations.

FIG. 2 illustrates an example independent content feed interface generated in response to selection of the content item summary control, according to disclosed implementations.

FIG. 3 illustrates an example search result page with a responsive independent content search result, according to disclosed implementations.

FIG. 4 illustrates an example search result page with a carousel of responsive independent content items, according to disclosed implementations.

FIG. 5 is a diagram that illustrates an example environment in which improved techniques described herein may be implemented.

FIG. 6 is a diagram that illustrates an example indexing flow for independent content items, according to disclosed implementations.

FIG. 7 is a diagram that illustrates an example method for providing a search result page that includes independent content items, according to disclosed implementations.

FIG. 8 is a diagram that illustrates an example method for ranking independent content items, according to disclosed implementations.

FIG. 9 is a diagram that illustrates an example of a distributed computer device that can be used to implement the described techniques.

### DETAILED DESCRIPTION

This disclosure relates to indexing, ranking, and search interfaces for independent content items. Independent content items are themselves resources that can be indexed and ranked as other resources, but are also anchored to (linked to) another resource. Independent content items are created by users and are hosted by a publisher that is different from, or independent of, the publisher of the other resources. Independent content items may be used as resources responsive to a query. Independent content items may be used to enhance a search result of another resource that is responsive to a query. Implementations may provide a feed interface that provides the ability to view a plurality of independent content items that are anchored to a particular resource. Items can be ranked in the feed interface using ranking signals unique to the independent content items.

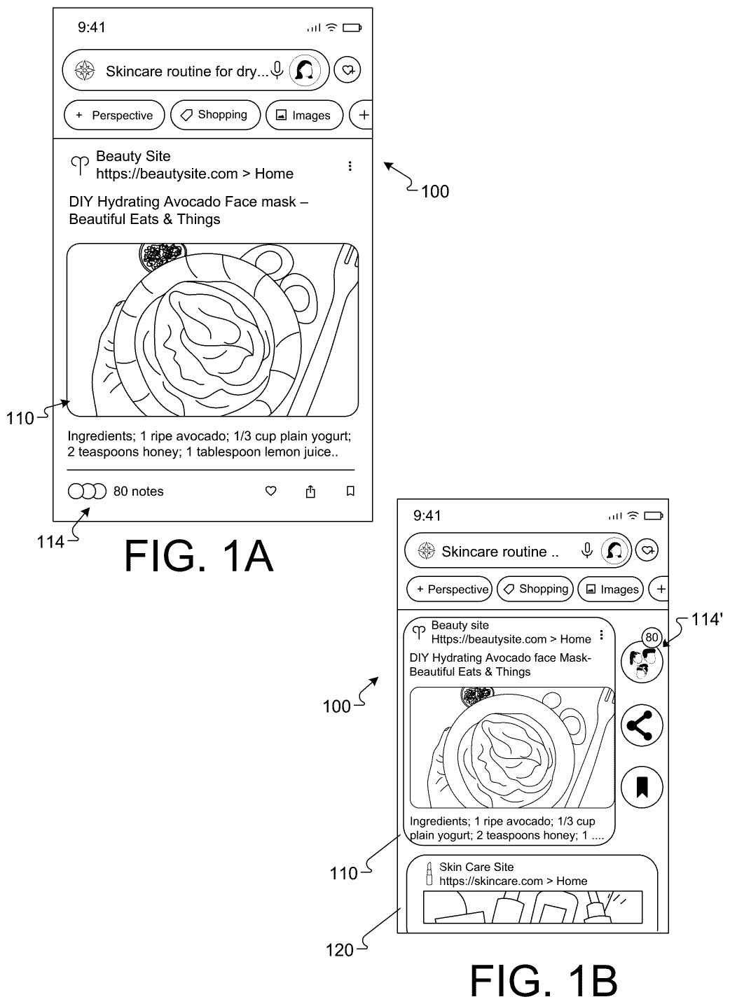

FIGS. 1A and 1B illustrate an example search result 110 with an independent content item summary control 114, according to disclosed implementations. While FIGS. 1A and 1B illustrate a user interface for a limited display area (e.g., for a mobile device), implementations are not limited to computing devices with limited display areas. The user interface elements described can be implemented in any computing device, including a computing device without a display (e.g., a voice assistant).

In the example of FIG. 1A, a search engine has received a query of skincare routines for dry skin and has generated a search result page 100 in response to the query. The search result page 100 includes a number of (quantity of) responsive resources, including a resource corresponding to search result 110. The search result 110 includes items typical for a search result for a webpage, including a title, a thumbnail image, and a document snippet. In addition, the search result 110 includes independent content item summary control 114. The independent content item summary control 114 is added to the search result 110 because the resource that corresponds to search result 110 (e.g., www.beautysite.com) is associated with (linked to, anchored to) independent content items. In the example of FIG. 1A, the resource corresponding to search result 110 is associated with at least 80 independent content items. In some implementations, the number of (quantity of) independent content items associated with (linked to) a resource is stored as an attribute of the resource, e.g., in a search index. In some implementations, a separate table may store the number of independent content items associated with a particular reference.

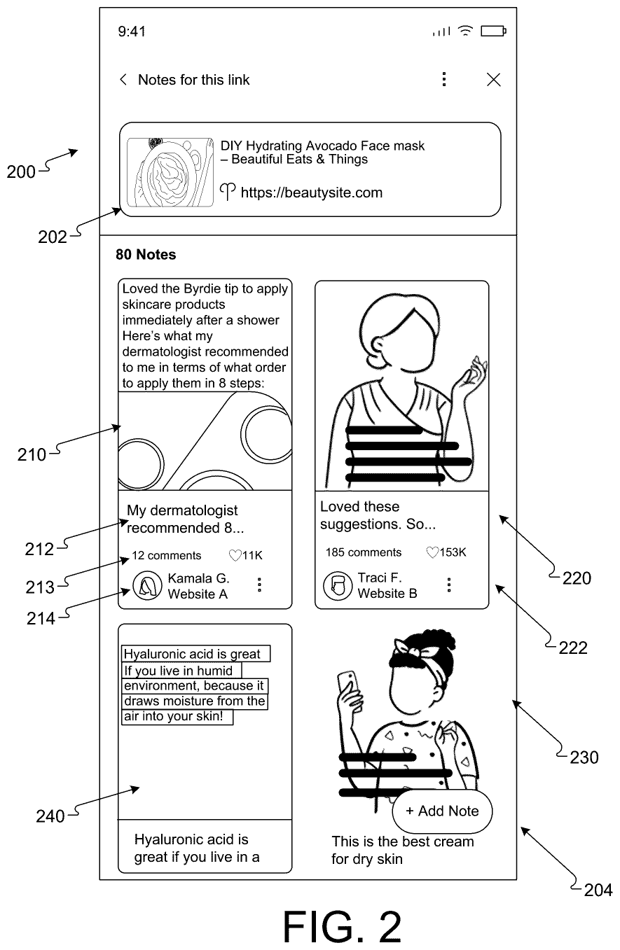

The independent content item summary control 114 can be any kind of selectable control. The independent content item summary control 114 may include images. The independent content item summary control 114 may include text. The independent content item summary control 114 may include images and text. In the example of FIG. 1A, the 114 includes images and text, the text indicating the number of independent content items linked to the resource, i.e., “80 Notes”. The image can be an icon. In some implementations, the image may consist of a profile image/profile images that correspond to one or more of the creators of the independent content items. The image and/or the text of the independent content item summary control 114 may be selectable by a user, using a same selection method as selecting a hyperlink. In response to selection, the independent content item summary control 114 may be configured to initiate display of (cause display of) an independent content item feed, as described with respect to FIG. 2.

FIG. 1B illustrates another example of an independent content item summary control 114′. In the example of FIG. 1B, the independent content item summary control 114′ is a selectable icon. In the example of FIG. 1B, a graphic, i.e., the bubble with the number 80, has been added conveying the number of independent content items linked to the resource associated with the search result 110. The search result page 100 of FIG. 1B also includes a second search result 120. The second search result 120 may or may not be associated with a respective independent content item summary control 114, depending on whether or not independent content items are linked to (associated with) the resource corresponding to the second search result 120. The independent content item summary control 114′ of FIG. 1B is configured in the same manner as the independent content item summary control 114 of FIG. 1A. In other words, in response to selection, the independent content item summary control 114′ may be configured to initiate display of (cause display of) an independent content item feed, as described with respect to FIG. 2.

FIG. 2 illustrates an example independent content feed interface 200 generated in response to selection of a content item summary control, such as independent content item summary control 114 or independent content item summary control 114′. The feed interface 200 includes independent content items linked to the same resource. In this example, the resource is a webpage located at beautysite.com. The independent content feed interface 200 can include a resource digest element 202. The resource digest element 202 may include a title for the resource, an icon (e.g., favicon) associated with the resource, a thumbnail image from the resource, a snippet or header from the resource, etc., depending on the display area available to the independent content feed interface 200. The independent content feed interface 200 can also include a new content item control 204. The new content item control 204 may be configured to initiate display of a user interface for adding a new independent content item. In some implementations, initiating display may include opening an application for adding a new independent content item.

The independent content feed interface 200 includes content item digest elements for the independent content items that are associated with the resource. In the example of independent content feed interface 200, four independent content item digest elements, digest element 210, digest element 220, digest element 230, and digest element 240, are illustrated. The independent content feed interface 200 is scrollable and additional content digest elements may be displayed in response to a scrolling input. The content item digest elements may be presented in an order determined by a ranking process performed on the independent content items associated with the resource. The ranking may consider not only topicality of the independent content items to the resource but also include other signals unique to independent content items. These signals can include a content creator score and/or various quality signals, such as helpfulness, as described herein. In some implementations, an affinity between the user and a particular content creator may be considered in ranking the independent content items. In some implementations, an independent content item may be associated with one or more flags that represent potentially inappropriate content. These flags may align with browser or profile settings that a user can select to filter out (exclude) certain categories of content. Independent content items associated with a flag matching a profile setting for excluding that type of content are excluded from the independent content feed interface 200.

The digest elements, e.g., digest element 210, digest element 220, digest element 230, digest element 240, can include attributes of and/or content from the respective independent content item. For example, digest element 210 includes an image from the independent content item, a title 212, engagement metrics 213, and creator profile 214. The engagement metrics 213 can include the number of (quantity of) comments, likes, shares, views, etc. The creator profile 214 can include a thumbnail of the creator's chosen profile picture, a public name of the creator, a date the content item was created and/or a publisher of the independent content item. The publisher can be a website or application used to create the content item or an identifier of the domain of the independent content system. The digest elements can also include a menu control, such as menu control 222. Selection of the menu control 222 may cause display of a user interface for viewing the corresponding independent content item, adding an engagement for the independent content item, etc.

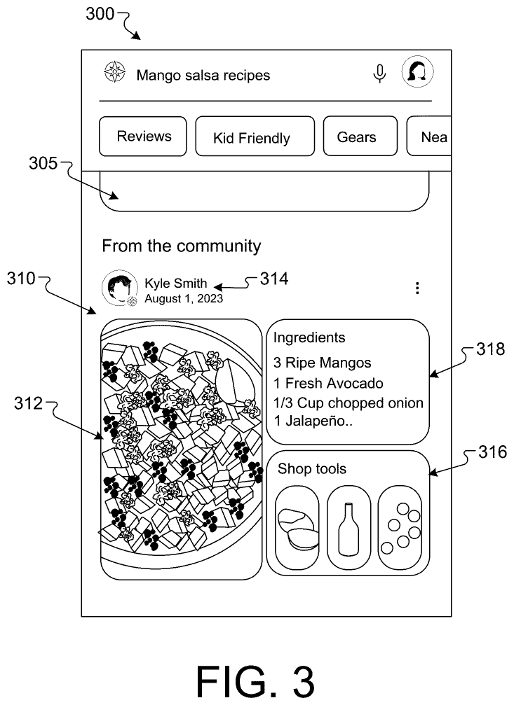

FIG. 3 illustrates an example search result page 300 with a responsive independent content search result 310, according to disclosed implementations. Because independent content items are themselves a type of webpage, the independent content items can be crawled and searched like any other resource and, therefore, can be documents responsive to a query based on the content item's relevance to the query. In some implementations, a search result for an independent content item may be the same as a search result for other websites. In some implementations, the search results for independent content items that are responsive to a query may be grouped together in a portion of the search result page. For example, a search result page can include an area (a carousel, a row, etc.) dedicated to independent content items that are responsive to the query, i.e., irrespective of whether the resource they link to (are associated with/are anchored to) is included in the search result page. In some implementations, this area dedicated to independent content items may be positioned after the first n search results (e.g., the first ten search results). In some implementations, the area dedicated to independent content items may hold a position of prominence, e.g., above the first n search results. In a display with a larger display area (e.g., desktop, laptop), the area dedicated to independent content items may be positioned above the fold.

In the example of FIG. 3, the search result page 300 includes a search result 305, which is followed by independent content search result 310. The independent content search result 310 of FIG. 3 may be an example of a responsive independent content item, i.e., an independent content item that is itself responsive to the query. Thus, the independent content search result 310 may be included among other responsive resources, and ranked in the same manner as other resources. In such an implementation, the title From the community may be provided as an indication of the type of resource. The independent content search result 310 of FIG. 3 may be an example of a search result page with an area (portion) dedicated to independent content items. For example, the title From the community may mark the beginning of the area dedicated to independent content items. In such an implementation, the independent content search result may be referred to as an independent content item overview. An independent content item overview may have different portions, similar to a search result for a web page having different portions, such as a title, a snippet, an icon, etc. In some implementations, search result 305 may represent the n′ resource responsive to the query. In the example of FIG. 3, the independent content search result 310 (independent content item overview) includes elements for different types of data elements included in the independent content item. In the example of FIG. 3, the search result includes the content item portion 312, a creator profile portion 314, a shopping portion 316, and an ingredient portion 318. The format of a search result for an independent content item may be based on the types of data attached to the independent content items.

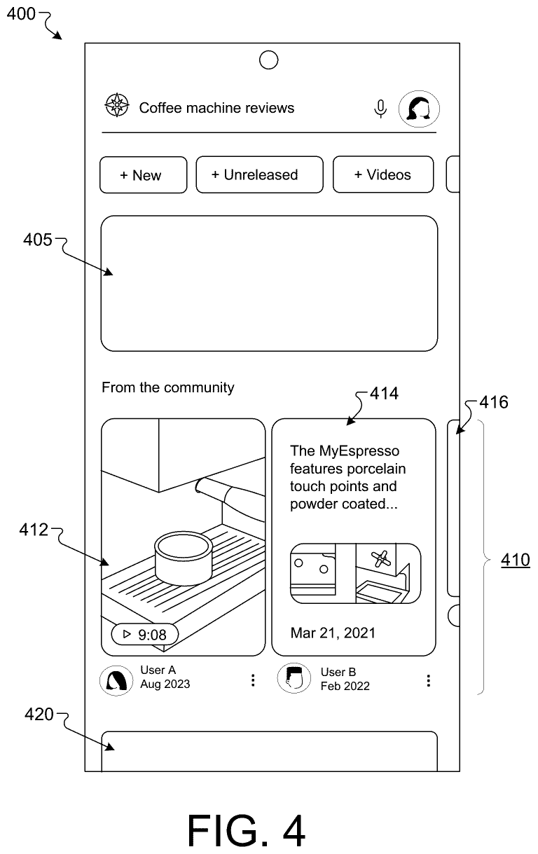

FIG. 4 illustrates an example search result page 400 with a carousel 410 of responsive independent content items, according to disclosed implementations. In the example of search result page 400, an area dedicated to independent content items that are responsive to the query are provided in a carousel format. Thus, in the example of FIG. 4, the user can scroll horizontally (left or right) using a scroll input to display digest elements for the different independent content items that are responsive to the query, e.g., digest element 412, digest element 414, digest element 416, etc. The independent content items represented by digest elements in carousel 410 can be identified and ranked separately from the other resources. In some implementations, independent content items may need a minimum quality signal and/or a minimum topicality signal to be included in the carousel 410. In other words, independent content items with a quality signal that fails to meet a quality threshold and/or topicality signal that fails to meet a topicality threshold may be filtered out. The independent content items included in the carousel 410 are not necessarily linked to (attached to) any of the resources that are responsive to the query. In some implementations, one or more of the independent content items may be attached to (link to) the query and may be included because they are linked to the query. In some implementations the query may have a resource locator that identifies a search engine and a search result, such as https://www.google.com/search?q=mango+salsa. In some implementations, one or more of the independent content items may be attached to (link to) an entity that is the topic of a query. For example, an independent content item may be attached to an entity that represents the city of Paris, France, and may be presented for a query determined to be topical to Paris, France. The search result page 400 of FIG. 4 also includes a search result 405 and a search result 420. The search result 405 and the search result 420 may be search results for relevant web pages, entities, documents, media files, a box answer, a factual panel, etc.

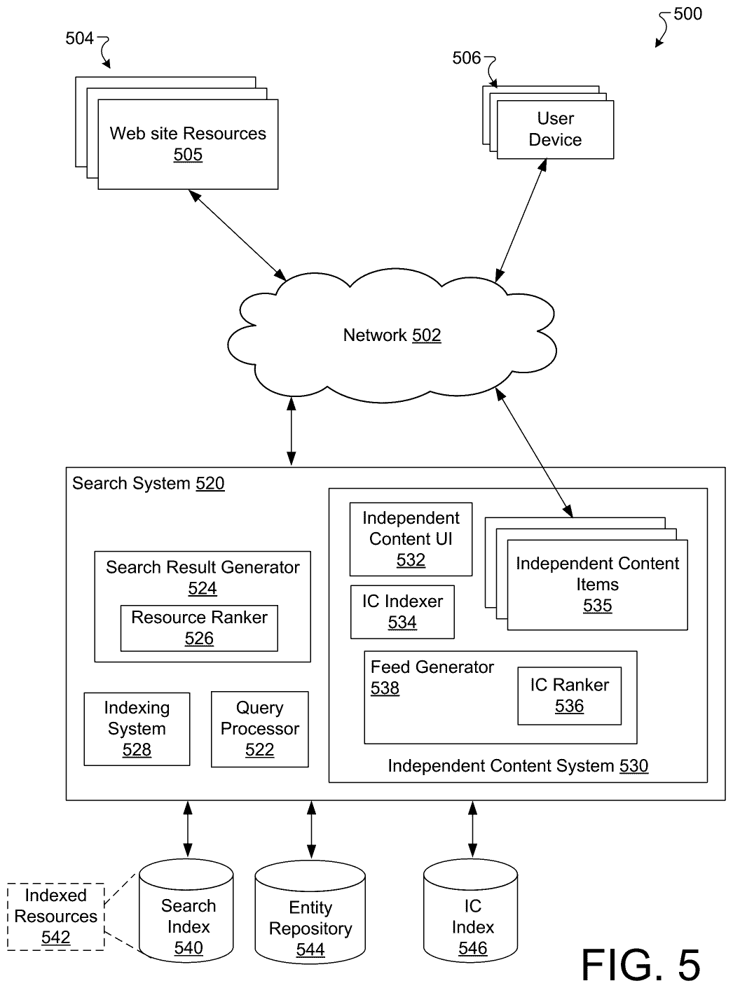

FIG. 5 is a diagram that illustrates an example environment 500 in which improved techniques described herein may be implemented. In the example of FIG. 5, an independent content system 530 is illustrated as part of a search system. However, the independent content system 530 can be independent of a search system 520. Moreover, while the search system 520 of FIG. 5 is described as an Internet search engine, the techniques here can be adapted to more specific search engines. For example, a shopping search engine, or a video search engine may include or may be in communication with an independent content system 530. As used herein, resources can refer to any content accessible to a search engine that has a unique locator. Thus, resources include webpages, images, documents, media, entities in an entity repository or other database, etc.

In the example of FIG. 5, the environment 500 includes a network 502, e.g., a local area network (LAN), wide area network (WAN), the Internet, or a combination thereof, connects web sites 504, user devices 506, and the search system 520. In some examples, the network 502 can be accessed over a wired and/or a wireless communications link. For example, mobile computing devices, such as smartphones can utilize a cellular network to access the web sites 504 and/or the search system 520. In some examples, the search system 520 can access the web site 504 via the Internet. The environment 500 may include millions of web sites 504 and user devices 506.

The search system 520 can include, among other things, an indexing system 528, a query processor 522, and a search result generator 524. In some implementations, the search system 520 can include an independent content system 530. In such implementations, the independent content system 530 may be able to trigger immediate indexing of newly created independent content items 535. In some implementations, the search system 520 can be in communication with, but separate from the independent content system 530. In some implementations, the search system 520 may crawl the independent content items 535 as if they were web site resources 505. In some implementations, the indexing system 528, query processor 522, and search result generator 524 may be co-located, e.g., at a server. In some implementations, one or more of the indexing system 528, the query processor 522, and/or the search result generator 524 may be remote from but communicatively coupled with each other, e.g., at different servers that communicate with each other. Any one of the query processor 522, search result generator 524, independent content system 530, and indexing system 528 can be implemented in a set of distributed servers.

In some examples, a web site 504 is provided as one or more resources 505, associated with an identifier, such as domain name, and hosted by one or more servers. An example web site is a collection of web pages formatted in an appropriate machine-readable language, e.g., hypertext markup language (HTML), that can contain text, images, multimedia content, and programming elements, e.g., scripts. Each web site 504 is maintained by a publisher, e.g., an entity that manages and/or owns the web site. Web site resources 505 can be static or dynamic (generated based on data provided in a request). In some examples, a resource 505 is data provided over the network 502 and that is associated with a resource address, e.g., a uniform resource locator (URL) also referred to as just a resource locator. In some examples, resources 505 that can be provided by a web site 504 include web pages, word processing documents, and portable document format (PDF) documents, images, video, and feed sources, among other appropriate digital content. The resources 505 can include content, e.g., words, phrases, images and sounds and may include embedded information, e.g., meta information and hyperlinks, and/or embedded instructions, e.g., scripts.

In some examples, a user device 506 is an electronic device that is under control of a user and is capable of requesting and receiving resources 505 over the network 502. Example user devices 506 include personal computers, mobile computing devices, e.g., smartphones, wearable devices, and/or tablet computing devices, etc., that can send and receive data over the network 502. As used throughout this document, the term mobile computing device (“mobile device”) refers to a user device with a limited display area that is configured to communicate over a mobile communications network. A smartphone, e.g., a phone that is enabled to communicate over the Internet, is an example of a mobile device, as are wearables and other smart devices such as smart speakers, although these may be considered as a different device type (e.g., a wearable type or a speaker type) than a smartphone. A desktop device can refer to a computing device conventionally used at a desk (e.g., a laptop, netbook, desktop, etc.). A user device 506 typically includes a user application, e.g., a web browser, to facilitate the sending and receiving of data over the network 502.

The user device 506 may include, among other things, a network interface, one or more processing units, memory, and a display interface. The network interface can include, for example, Ethernet adaptors, Token Ring adaptors, and the like, for converting electronic and/or optical signals received from the network to electronic form for use by the user device 506. The set of processing units includes one or more processing chips and/or assemblies. The memory includes both volatile memory (e.g., RAM) and non-volatile memory, such as one or more ROMs, disk drives, solid state drives, and the like. The set of processing units and the memory together form controlling circuitry, which is configured and arranged to carry out various methods and functions as described herein. The display interface is configured to provide data to a display device for rendering and display to a user.

In some examples, to facilitate searching of resources 505, the search system 520 includes an indexing system 528 that identifies the resources 505 by crawling and indexing the resources 505 provided on web sites 504. The indexing system 528 may index data about and content of the resources 505, generating search index 540. Because the newly created independent content items 535 have their own resource address (their own URL), the independent content items 535 can also be crawled and indexed by the indexing system 528 using the same processes used to crawl and index resources 505. In implementations where the independent content system 530 is integrated with the search system 520 (including as a distributed system), the newly created independent content items 535 can also be indexed in real-time, as explained herein.

In some implementations, the fetched and indexed resources 505 and any fetched and indexed independent content items 535 may be stored as indexed resources 542. In some implementations, the search index 540 and/or the indexed resources 542 may be stored at the search system 520. In some implementations, the search index 540 and/or the indexed resources 542 may be accessible to the search system 520. In some implementations, the search system 520 may have access to an entity repository 544. In some implementations, the independent content system 530 may have access to the entity repository 544. The entity repository 544 can be accessed to provide factual responses to a factual query, to help with ranking resources responsive to a query, and/or to provide a resource for an independent content item 535 to link to (to be anchored to, to be associated with). The entity repository 544 can be referred to as a knowledge base, a knowledge graph, or a fact repository. In some implementations, the search system 520 may use the entity repository 544 to generate a box answer or a factual panel (knowledge panel) in response to a query that corresponds to an entity. In some implementations, the format of the knowledge panel may be based on the vertical of the query (e.g., a sports entity, a shopping entity, a person entity, a movie entity, etc.).

In some implementations, the search system 520 may have access to independent content item index 546. Independent content item index 546 can represent an index of independent content items 535. The independent content item index 546 may include attributes about the independent content items 535. The independent content items 535 can be used to identify all independent content items 535 that are anchored to a particular resource. The independent content items 535 may include a title for each independent content item. Titles can be used in ranking independent content items. Titles may be a minimum length, in number of characters, (e.g., 10 characters, 15 characters) to qualify as a ranking signal. In some implementations, the title may have a maximum length (e.g., 20, 25, 30, 35, 40 characters, etc.). This enables the title to serve as a snippet in a search result. The independent content items 535 may include a description. The description may include hashtags, emojis, keywords, etc. for the independent content item. The title and description of an independent content item 535 is provided by the creator of the content item. The independent content item index 546 may include a profile image and/or a profile name for the creator of the independent content item 535.

The independent content item index 546 can include the resource locator of the resource the independent content items 535 are linked to (anchored to/associated with). The independent content item index 546 may include the publisher of the independent content items 535. The publisher can be identified by a domain hosting the independent content items 535. In some implementations, the independent content item index 546 may include a publisher logo. The independent content item index 546 may include an identifier for an image (e.g., cover image, preview image) to be used in search results for the independent content items 535. In some implementations, a description of and/or caption for the image may be included in the independent content item index 546. In some implementations, the independent content item index 546 may indicate whether the image is from a template. In some implementations, the independent content item index 546 may indicate, for an image, flags related to appropriateness so that users who block certain flags will not have independent content items with those flags presented to them. The independent content item index 546 can include a respective timestamp for each of the independent content items 535. The timestamp can be a creation date/time. The timestamp can be an update date/time. The independent content items 535 may include a respective location associated with each of the independent content items 535. The location is a generalized location, e.g., country, region, area code, etc. In some implementations, the independent content item index 546 may include a respective language for the independent content items 535. In some implementations, the independent content item index 546 may store respective engagement signals for the independent content items 535. Engagement signals can include the number of impressions, the number of views, the number of clicks, the number of likes (i.e., positive sentiment signals), and/or the average linger time. In some implementations, the engagements can include the number of dislikes (i.e., negative sentiment signals). The independent content item index 546 can include other attributes (metadata) about the individual independent content items 535 that help with ranking and serving independent content items 535.

The user devices 506 submit search queries to the search system 520. In some examples, a user device 506 can include one or more input modalities. Example input modalities can include a keyboard, a touchscreen, a camera, a mouse, a stylus, and/or a microphone. For example, a user can use a keyboard and/or touchscreen to type in a search query. As another example, a user can speak a search query, the user speech being captured through the microphone, and processed through speech recognition to provide the search query. As another example, a user can submit an image or an area of an image as a query.

The search system 520 may include query processor 522 and/or search result generator 524 for responding to queries issued to the search system 520. In response to receiving a search query, the query processor 522 may process (parse) the query and access the search index 540 to identify indexed resources 542 that are relevant to the search query, e.g., have at least a minimum specified relevance score for the search query. Processing the query can include applying natural language processing techniques and/or template comparison to determine a topical entity of the query. The query processor 522 may perform disambiguation if the topical entity in a query is ambiguous.

The search system 520 may identify the indexed resources 542 that are responsive to the query and generate a search result page. The search result page includes search results and can include other content, such as ads, entity (knowledge) panels, box answers, entity attribute lists (e.g., songs, movie titles, etc.), short answers, generated responses (e.g., from a large language model), other types of rich results, links to limit the search to a particular resource type (e.g., images, travel, shopping, news, videos, etc.), other suggested searches, etc. In some implementations, the search result page may include a portion dedicated to responsive independent content items 535.

Each search result corresponds to a resource available via a network, e.g., via a resource locator, such as a URL/URI/etc. The resources represented by search results are determined by the search result generator 524 to be top ranked resources that are responsive to the query. The search result generator 524 includes a resource ranker 526 configured to determine and order in which to provide search results in the search result page. The resource ranker 526 may use signals of (attributes about) a resource to determine the ranking order. The resource ranker 526 can include a process that determines similarity between a resource and the query. A search result page may include a subset of search results initially, with additional search results (e.g., for lower-ranked resources) being shown in response to a user selecting a next page of results (e.g., either by selecting a ‘next page’ control or by continuous scrolling, where new search results are generated after a user reaches and end of a currently displayed list but continues to scroll).

Each search result includes a link to a corresponding resource. Put another way, each search result includes a link to a publisher (e.g., web site 504 or independent content system 530) from the search result page. Each search result may be considered to represent/be associated with a resource. Because the independent content items 535 can be included in the indexed resources 542 the search results can include one or more responsive independent content items 535. Any independent content items 535 included in the search results can be ranked, e.g., by the resource ranker 526, in the same manner as other responsive resources.

The search result can include additional information, such as a title from the resource, a portion of text obtained from the content of the resource (e.g., a snippet), an image (thumbnail) associated with the resource, etc., and/or other information relevant to the resource and/or the query, as determined by the search result generator 524 of the search system 520. In some implementations, the search result may include a snippet from the resource and an identifier for the resource. For example, where the query was issued from a device or application that received the user query via voice, the search result may be a snippet that can be presented via a speaker of the user device 506.

In some implementations, the search result generator 524 may have access to the independent content item index 546. In some implementations, this may be via an application program interface. In such implementations, the search result generator 524 may access independent content item index 546 to determine whether or not to include an independent content item summary control for a particular search result. The independent content item summary control may be added to a search result in response to the associated resource having one or more independent content items linked to the resource. In some implementations, the number of independent content items linked to the resource may be an attribute of the resource, e.g., stored in the search index 540. In such implementations, the search result generator 524 can determine whether to include an independent content item summary control for a search result without accessing independent content item index 546. In some implementations, the independent content system 530 may include a periodic process (e.g., every x hours) that updates this attribute in the search index 540. In some implementations, a table may store the number of independent content items 535 anchored to a resource. The table can be maintained by the independent content system 530. In such implementations, the search result generator 524 may have access to the table, which can be updated in real time by the independent content system 530 and/or by the search system 520 (e.g., by indexing system 528 as independent content items 535 are crawled). Independent content item summary control 114 and independent content item summary control 114′ are examples of independent content item summary controls that can be added to a search result. Where the resource is a topical entity, an independent content item summary control can be added to an entity panel in the search result page and/or the search result page may include a portion dedicated to independent content items (e.g., as illustrated in FIG. 3 and FIG. 4).

In some implementations, the search result page may include a portion dedicated to responsive independent content items 535. In such an implementation, search result generator 524 may access the independent content item index 546 to determine whether any independent content items 535 are linked to (associated with/anchored to) the query or to a topical entity of the query. If any of the independent content items 535 are anchored to the query and/or to the topical entity, the search result generator 524 may generate a portion dedicated to responsive independent content items 535. FIG. 3 and FIG. 4 illustrate an example dedicated portion.

The search result generator 524 may include a component configured to format the search result page for display or output on a user device 506. The search system 520 returns the search result page to the query requestor. For a query submitted by a user device 506, the search result page is returned to the user device 506 for display, e.g., within a browser, on the user device 506.

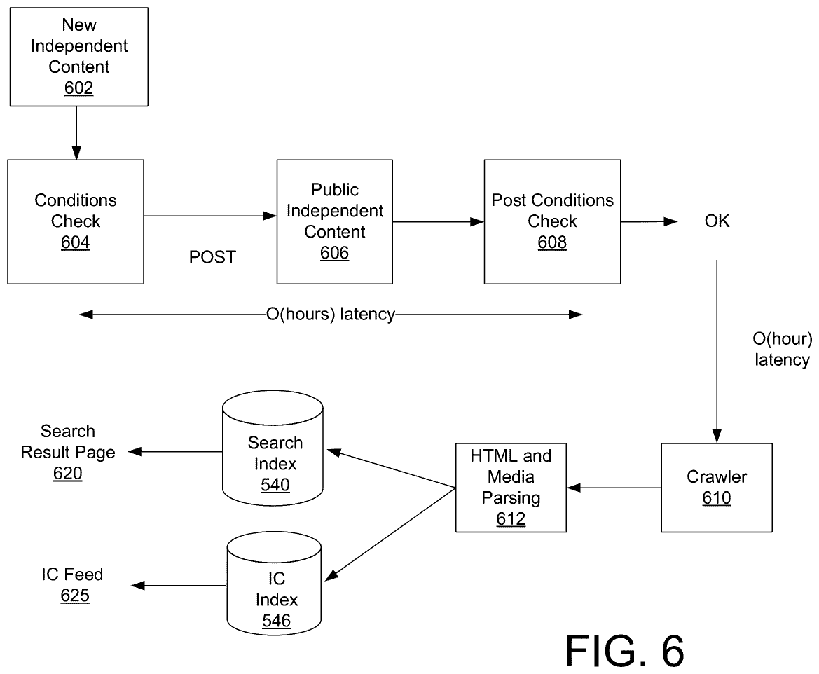

In disclosed implementations, the environment 500 includes an independent content system 530. In some implementations, the independent content system 530 is integrated with the search system 520. The independent content system 530 may be used to generate individual content items 535, e.g., via independent content user interface 532. The independent content system 530 may be the publisher (host) of the independent content items 535. The independent content user interface 532 may be configured to cause indexing of independent content items 535 as the independent content items 535 is created and published (posted), as explained in more detail with regard to FIG. 6. The independent content user interface 532 may be configured to trigger removal of independent content items 535 from the independent content item index 546 and/or the search index 540 in response to deletion of an independent content item, a request to unpublish (un-post) an independent content item, and/or a creator account deletion.

The independent content system 530 may include an independent content indexer 534. The independent content indexer 534 may be configured to add newly published independent content items 535 to the independent content item index 546. This may include generating ranking signals used by the independent content ranker 536 that are not dependent on a query. An example of such a signal is the relevance of the independent content item to the resource it is anchored to. In some implementations, where the resource the independent content item is anchored to is a web site resource (e.g., web site resource 505), the independent content indexer 534 may treat the independent content item as a query and the web site resource as a document and use an existing process to calculate similarity between the “query” (the independent content item) and the resource (the linked-to web site resource). In some implementations, the independent content indexer 534 may calculate a document-to-document similarity. This similarity score can be stored as an attribute of the independent content item. The attribute may be stored in the independent content item index 546. The attribute (and other ranking attributes) may be stored in a table or data repository, i.e., a ranking attribute table. This similarity score can be referred to as a topicality score. In some implementations, where the resource the independent content item is anchored to is a query or an entity, the independent content indexer 534 may calculate a topicality score by using the independent content item as the document and calculating a query (or entity)-to-document similarity score.

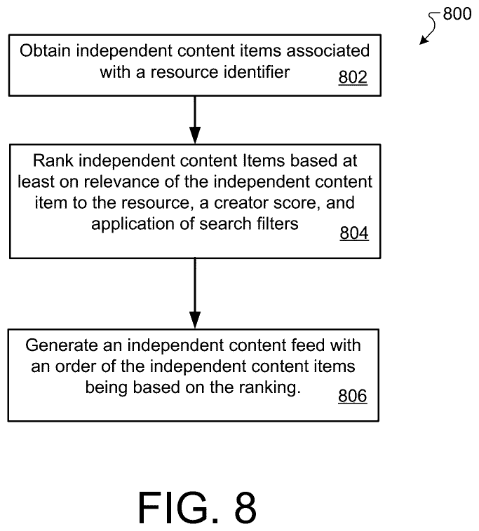

In some implementations, the independent content indexer 534 may generate quality signals for the independent content items 535. The quality signals may also be attributes of the independent content items 535 (e.g., stored in a ranking attribute table or as part of the independent content item index 546). The quality signals are discussed in more detail with respect to FIG. 8. In some implementations, the independent content system 530 may calculate a creator score. The creator score may be based on the quality scores and/or topicality scores of the independent content items generated by the creator. The creator score can be associated with a profile of the creator. The creator score may be based on helpfulness scores generated by a generative model (large language model, large vision model, or a combination of these) for independent content items published (posted) by the creator. A generative model is a model that has a high number of parameters (e.g., millions, billions, hundreds of billions) and is commonly based on a transformer architecture. These generative models can synthesize text and/or images provided as input and provide an output that reflects an analysis of the input. For example, a generative model may be given the independent content item and asked to classify the helpfulness of the independent content. The classification can be binary (e.g., helpful/not helpful). The classification can be based on a helpfulness confidence score (e.g., 1.0=most helpful and 0=least helpful). The creator score can be based on how helpful the independent content items posted by the creator are. For example, the creator score can be an average or mean of the helpfulness confidence score. As another example, the creator score can be a ratio of helpful to non-helpful independent content items. As another example, the creator score can represent a quartile of the creator compared to other creators. The creator score can be generated on a periodic basis.

FIG. 6 is a diagram that illustrates an example indexing flow for independent content items, according to disclosed implementations. The indexing flow can be executed in an environment, such as environment 500. A creator may use independent content user interface 532 to create a new independent content item 602. In some implementations, the independent content items may be checked (604) for compliance with terms and conditions for using the independent content user interface 532. This can include, for example, the conditions check 604 may ensure that the new independent content item 602 has a title and other basic structural items needed for the new independent content item 602 to be stored and indexed by the system. Once the creator has finished the new independent content item 602, the creator may post (publish) the new independent content item 602, making the independent content item a public independent content item 606. In some implementations, posting (publishing) can initiate a conditions check (608) after posting. The post-conditions check 608 may evaluate the content of the new independent content item 602. In some implementations, the post conditions check (608) may add a flag/flags that represents potentially inappropriate content, if such a flag (or flags) apply to the new independent content item 602. Passing the conditions check, the new independent content item 602 is assigned a unique resource locator (e.g., a unique URL). The unique resource locator can uniquely identify the combination of the creator and the independent content item. The unique resource locator can include a domain of the publisher. In some implementations, once assigned a unique resource locator, the resource locator can be sent to a crawler 610 for immediate crawling. Thus, there is minimal latency between when the new independent content item 602 is posted and when the URL is crawled. The crawler 610 can be an existing crawler process, e.g., for a search engine. In some implementations, the independent content system 530 may use an API for the crawler 610 to trigger the crawling of the new independent content item 602. In some implementations, a sitemap can be used to process large numbers of URLs. In some implementations, when the new independent content item 602 is posted (generated or updated), the URL for the new independent content item 602 is added into a sitemap, which will trigger the crawler 610 and parsing 612. In some implementations, the independent content items may be associated with a content type tag that differentiates it from other types of resources. The sitemap and the tag may be used to trigger the crawler 610. In some implementations, once assigned a unique resource locator, the new independent content item 602 can be uploaded/submitted for immediate processing. In such implementations, the crawler 610 is not used. Instead, the system enables the uploaded/submitted content of the independent content item 602 to be provided immediately for parsing 612.

After crawling or submission, the new independent content item 602 is subject to parsing 612, e.g., the text, images, media files may be parsed using the same process used for parsing other resources. In some implementations, media and/or image parsing may take longer than text parsing. Once parsing is complete, the search index 540 may be updated with the data from/for the new independent content item 602. In addition, the independent content item index 546 may be updated with data from/for the new independent content item 602. Once the search index 540 and/or the independent content item index 546 are updated, the new independent content item 602 can be included in a search result page 620 and/or in an independent content feed interface 625.

Parsing 612 can include updating a data structure that stores the number of independent content items that are linked to (anchored to) a particular resource. Parsing 612 can also trigger online and offline processes to generate quality-related signals. In some implementations, parsing 612 can calculate ranking signals when the new independent content item 602 is indexed, i.e., added to the search index 540. The ranking signals can include quality and topicality signals. In some implementations, these ranking signals can be stored in a separate table or as attributes of the independent content item (e.g., in the independent content item index 546). In some implementations, ranking signals can be updated. For example, an independent content item might get new quality signals in response to an update to one of the models (e.g., the LLMs/LVMs) that generate the quality signals or if a new signal is added. In some implementations, the system may reprocess all the independent content items and compute/determine the value of the new signal for that content.

Returning to FIG. 5, the independent content system 530 can include a feed generator 538. The feed generator 538 generates a user interface listing independent content items 535 that are linked to (anchored to) the same resource, e.g., independent content feed interface 200 of FIG. 2. The independent content feed interface may list content item digest elements in an order determined by ranker 536. The ranker 536 may consider not only topicality of the independent content items to the resource but also a content creator signal (e.g., with a creator having a higher helpfulness signal receiving a boost in ranking) and/or various quality signals, such as helpfulness, as described herein. In some implementations, an affinity between the user and a particular content creator may be considered in ranking the independent content items. In some implementations, an independent content item may be associated with one or more flags that represent potentially inappropriate content. As explained herein, these flags can be used to filter out (exclude) certain categories of content from the independent content feed interface. In some implementations, the feed generator 538 may exclude independent content items that fail to meet a quality threshold. Whether or not an independent content item meets a quality threshold can be based on the quality score of the independent content item. Whether or not an independent content item meets a quality threshold can be based on the quality score of the independent content item and user interactions with the independent content item. In some examples, independent content items may be assigned a quality score and the quality score is compared to the quality threshold. The quality score may reflect a variety factors, such as how well any images relate to the textual content, how well the title relates to the content, whether the title is more than a minimum number of characters, how similar the images are to copyrighted images, etc. In some implementations, a language and/or vision model (LLM/LVM) may be used in assigning the quality score. Such models may base the quality score in part on content understanding.

Although illustrated as part of the independent content system 530 in FIG. 5, one or more components may be separate from the independent content system 530 but accessible to the independent content system 530, e.g., via an API call. For example, the independent content indexer 534 may use a query-to-document or document-to-document similarity service provided by the search system 520 or another system. Put another way, the independent content system 530 may use existing processes for certain functions.

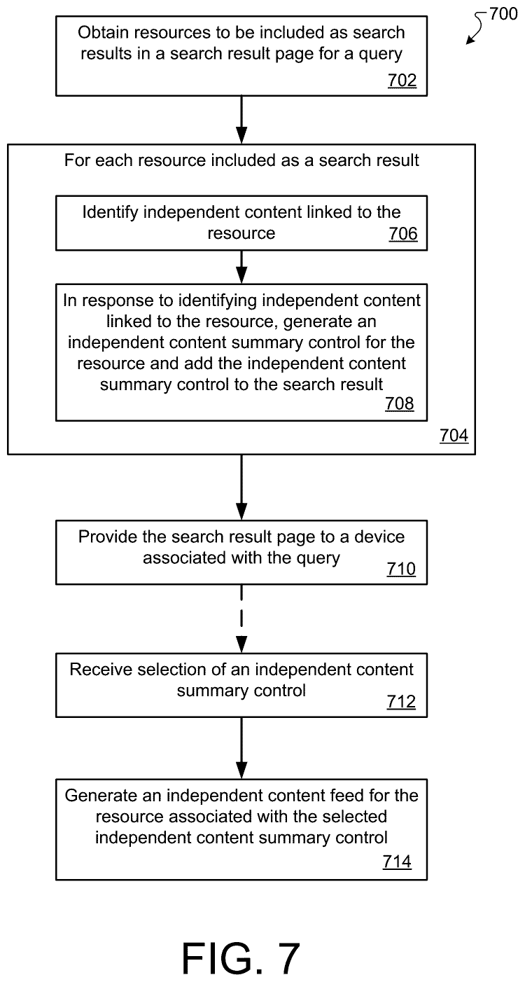

FIG. 7 is a diagram that illustrates an example method 700 for providing a search result page that includes independent content items, according to disclosed implementations. Method 700 may be executed in an environment, such as environment 500. In some implementations, one or more of the method steps may be executed by a system, such as search result generator 524 and/or independent content system 530 of FIG. 5. Not all steps need to be performed in some implementations. Additionally, the method steps can be performed in an order other than that depicted in FIG. 7.

At step 702, the system obtains resources to be included as search results in a search result page for a query. The resources can include any resource with a resource locator, such as a URL/URI. The resource can be an entity from an entity repository. In some implementations, the resources to be included as search results in the search result page may include the highest-ranked n resources, where n is a predetermined number (e.g., 10, 15, 50, etc.). In some implementations, the resources to be included as search results in the search result page may include resources that have a minimum relevance to the query. At step 704, for each resource that is to be included, the system determines whether or not to add an independent content item summary control to the search result for the resource. To determine whether or not to provide the independent content item summary control, at step 706, the system may identify independent content items that link to (are anchored to) the resource. In some implementations, the system may include a table that associates the number of independent content items that are linked to the resource or the resource may store the number of independent content items anchored to it as an attribute, and step 706 may include obtaining the number from the table or the attribute. In some implementations, the system may use an index of independent content items 535 to identify any independent content items linked to the resource. If any independent content items 535 are identified (e.g., the number is greater than zero), at step 708, the system adds an independent content item summary control to the search result of that content item. FIG. 1A and FIG. 1B illustrate examples of a search result with an independent content item summary control 114 added.

At step 710 the search result page is provided to a user device associated with the query (i.e., a user device from which the query was received). The user may or may not interact with the independent content item summary control. If the user does interact with the independent content item summary control, i.e., by selecting the independent content item summary control, at step 712 the system may receive the selection and, at step 714, may generate an independent content feed interface for the resource associated with the selected independent content item summary control. For example, the system may determine which independent content items are linked to the resource, rank the items (e.g., using ranker 536) and generate digest elements for the independent content items linked to the resource. FIG. 2 illustrates such an example independent content feed interface.

FIG. 8 is a diagram that illustrates an example method 800 for ranking independent content items and generating an independent content item feed, according to disclosed implementations. Method 800 may be executed in an environment, such as environment 500. In some implementations, one or more of the method steps may be executed by a system, such as independent content system 530 of FIG. 5. In some implementations, one or more of the method steps may be executed by a model, such as an independent content ranking model. Not all steps need to be performed in some implementations. Additionally, the method steps can be performed in an order other than that depicted in FIG. 8.

At step 802, the system obtains independent content items associated with a resource identifier (e.g., URL). The resource identifier is a resource that the independent content items were associated with when they were created. The resource can be any resource (webpage, media file, image, etc.) available over a network, such as the Internet. The resource can be a resource associated with a search result of a search result page.

At step 804, the system ranks the independent content items. Because the independent content items can be processed like any other resource, search content and creator content signals for these other resources are available for ranking the independent content items. In addition, have all necessary Search content level and creator level signals available based at least one topicality of the independent content item to the resource and a creator score. The topicality of a content item to its anchored resource can be calculated independent of a request to generate an independent content item feed. In some implementations, the system may treat the independent content item as a query and the resource as a document and use an existing process to return a topicality score. In other words, the system may use a query-to-document similarity process. This process can be a service provided by a search engine. In some implementations, text associated with the independent content item is used as the query. In some implementations, the system may treat the independent content item as a document, removing add-on items, and use an existing process to determine relevance with the resource. In other words, the system may use a document-to-document topicality process. In some implementations, a topicality score may be stored as part of the independent content item index, e.g., independent content item index 546. In some implementations, the topicality scores can be calculated/re-calculated periodically, e.g., as a batch job that runs every x hours or every y days.

The quality signals can include an informational content signal, a standalone signal representing the ability of the item to serve as a standalone resource, a language quality signal, an authenticity signal, a sentiment signal representing whether the item has a sentiment that is negative or positive, etc. The authenticity signal may be obtained from a language model trained to recognize text that is experienced based and/or opinion based. Thus, an authenticity signal may indicate whether the content reflects an opinion or personal experience. The quality signals can include a helpfulness signal. Helpfulness can be based on the number of user engagements associated with the independent content item. User engagements include likes/upvotes, comments, views, etc.

In some implementations, one or more generative models, such as large language models (LLM/LLMs) or large vision models (LVM/LVMs) may be used to provide a quality signal (quality score) for the independent content items. The generative model or collection of generative models (also referred to as an independent content quality model(s)) may take the text of an independent content item as input and may be trained to provide a classification of and/or a score for the independent content item as output, The classification/score may be based on several signals, including how helpful and/or informative the item is, how inspirational or entertaining the item is, the aesthetic quality of the item, readability, etc. Some or all of these characteristics can be determined by trained models. In some implementations, the quality signal may be used to filter out independent content items. In other words, independent content items having a quality score that fails to meet a quality threshold may be filtered out (excluded) from the independent content items in the independent content feed interface. In some implementations, the quality signal may be used to rank independent content items.

In some implementations, because the independent content items are indexed as other resources, signals (flags) that detect potentially inappropriate content can be added to the index and used to filter out independent content items. A browser setting or settings may determine which signals (flags) to exclude.

At step 806, the system generates an independent content feed interface for presentation to the user. The independent content feed interface may display the independent content items in an order that is based on the ranking (step 804).

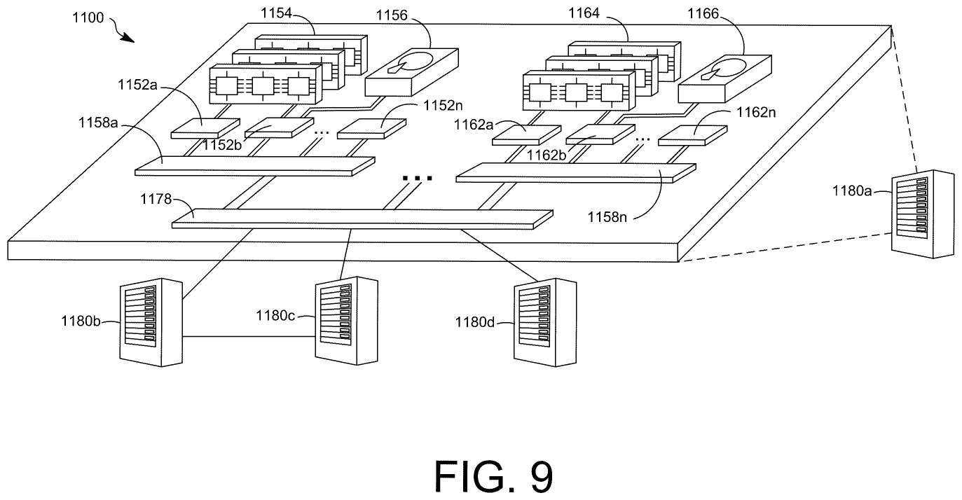

FIG. 9 shows an example of a computing device 1100, which may be search system 520 and/or the independent content system 530 of FIG. 5, which may be used with the techniques described here. Computing device 1100 is intended to represent various example forms of large-scale data processing devices, such as servers, blade servers, datacenters, mainframes, and other large-scale computing devices. Computing device 1100 may be a distributed system having multiple processors, possibly including network attached storage nodes, that are interconnected by one or more communication networks. The components shown here, their connections and relationships, and their functions, are meant to be examples only, and are not meant to limit implementations of the implementations described and/or claimed in this document.

Computing device 1100 may be a distributed system that includes any number of computing devices 1180 (e.g., 1180a, 1180b, . . . 1180n). Computing devices 1180 may include a server or rack servers, mainframes, etc. communicating over a local or wide-area network, dedicated optical links, modems, bridges, routers, switches, wired or wireless networks, etc.

In some implementations, each computing device may include multiple racks. For example, computing device 1180a includes multiple racks (e.g., 1158a, 1158b, . . . , 1158n). Each rack may include one or more processors, such as processors 1152a, 1152b,., 1152n and 1162a, 1162b, . . . , 1162n. The processors may include data processors, network attached storage devices, and other computer-controlled devices. In some implementations, one processor may operate as a master processor and control the scheduling and data distribution tasks. Processors may be interconnected through one or more rack switches 1162a-1162n, and one or more racks may be connected through switch 1178. Switch 1178 may handle communications between multiple connected computing devices 1100.

Each rack may include memory, such as memory 1154 and memory 1164, and storage, such as 1156 and 1166. Storage 1156 and 1166 may provide mass storage and may include volatile or non-volatile storage, such as network-attached disks, floppy disks, hard disks, optical disks, tapes, flash memory or other similar solid state memory devices, or an array of devices, including devices in a storage area network or other configurations. Storage 1156 or 1166 may be shared between multiple processors, multiple racks, or multiple computing devices and may include a non-transitory computer-readable medium storing instructions executable by one or more of the processors. Memory 1154 and 1164 may include, e.g., volatile memory unit or units, a non-volatile memory unit or units, and/or other forms of non-transitory computer-readable media, such as a magnetic or optical disks, flash memory, cache, Random Access Memory (RAM), Read Only Memory (ROM), and combinations thereof. Memory, such as memory 1154 may also be shared between processors 1152a-1152n. Data structures, such as an index, may be stored, for example, across storage 1156 and memory 1154. Computing device 1100 may include other components not shown, such as controllers, buses, input/output devices, communications modules, etc.

An entire system may be made up of multiple computing devices 1100 communicating with each other. For example, device 1180a may communicate with devices 1180b, 1180c, and 1180d, and these may collectively be known as independent content system 530, search result generator 524, indexing system 528, query processor 522, and/or search system 520. Some of the computing devices may be located geographically close to each other, and others may be located geographically distant. The layout of computing device 1100 is an example only and the system may take on other layouts or configurations.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) LCD (liquid crystal display), or LED monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of implementations have been described. Nevertheless, it will be understood that various modifications may be made without departing from the spirit and scope of the specification.

It will also be understood that when an element is referred to as being on, connected to, electrically connected to, coupled to, or electrically coupled to another element, it may be directly on, connected or coupled to the other element, or one or more intervening elements may be present. In contrast, when an element is referred to as being directly on, directly connected to or directly coupled to another element, there are no intervening elements present. Although the terms directly on, directly connected to, or directly coupled to may not be used throughout the detailed description, elements that are shown as being directly on, directly connected or directly coupled can be referred to as such. The claims of the application may be amended to recite example relationships described in the specification or shown in the figures.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims. Moreover, as used herein, ‘a’ or ‘an’ entity may refer to one or more of that entity.

What is claimed is:

1. A method comprising:
identifying, by a search engine, resources to be included as search results in a search result page for a query;
for at least one resource of the resources:
identifying a quantity of independent content items anchored to the resource, each independent content items having a respective resource locator that is indexed by the search engine, and
adding an independent content item summary control to the search result for the resource, the independent content item summary control configured to initiate an independent content feed interface; and
providing the search result page to a device associated with the query.

2. The method of claim 1, further comprising:
receiving a selection of the independent content item summary control; and
in response to receiving the selection, generating the independent content feed interface, the independent content feed interface including digest elements for independent content items anchored to the resource.

3. The method of claim 2, wherein generating the independent content feed interface includes ranking the independent content items based at least on quality scores and topicality scores, the topicality scores representing topicality to the resource.

4. The method of claim 3, wherein the topicality scores are generated by treating the independent content items as queries and the resource as a document in a query-to-document similarity process.

5. The method of claim 3, wherein a quality score for an independent content item is based at least on an engagement signal and a language quality signal.

6. The method of claim 3, wherein a quality score for an independent content item is based at least on a classification from a generative model given the independent content item.

7. The method of claim 3, wherein the ranking is further based on creator scores, where a creator score for a creator is based on the quality scores for independent content items attributed to the creator.

8. The method of claim 3, wherein the ranking filters out independent content items that have a quality score that fails to meet a quality threshold.

9. The method of claim 1, wherein the independent content items anchored to the resource have a publisher that differs from a publisher of the resource.

10. The method of claim 1, wherein the quantity of independent content items anchored to the resource is stored as an attribute of the resource.

11. The method of claim 1, wherein at least one search result of the search results is for an independent content item.

12. The method of claim 1, further comprising:
triggering immediate crawling of a new independent content item;
crawling the new independent content item; and
adding the new independent content item to an index for the search engine.

13. A system comprising:
memory storing independent content items, each independent content item being anchored to a resource and having a respective resource locator;
an index associating terms with resources, the resources including the independent content items;
at least one processor; and
memory storing instructions that, when executed by the at least one processor, cause the system to perform operations including:
identifying, using the index, resources to be included as search results of a search result page for a query,
for at least one resource of the resources:
determining that a quantity of the independent content items are anchored to the resource, and
adding an independent content item summary control to the search result for the resource, the independent content item summary control configured to initiate an independent content feed interface, and
providing the search result page to a device associated with the query.

14. The system of claim 13, the operations further comprising:
receiving a selection of the independent content item summary control; and
in response to receiving the selection, generating the independent content feed interface, the independent content feed interface including digest elements for independent content items anchored to the resource.

15. The system of claim 14, wherein generating the independent content feed interface includes ranking the independent content items based at least on quality scores, creator scores, and topicality scores, the topicality scores representing topicality to the resource, and where a creator score for a creator is based on the quality scores for independent content items attributed to the creator.

16. The system of claim 13, wherein the quantity of independent content items anchored to the resource is stored as an attribute of the resource in the index.

17. A method comprising:
identifying, by a search engine, resources to be included as search results in a search result page for a query, at least one of the resources being an independent content item that anchors to another resource that is not a resource included in the search results;
generating, as the search result for the independent content item, an independent content item overview; and
providing the search result page, including the independent content item overview, to a device associated with the query.

18. The method of claim 17, further comprising:
generating, on the search result page, a portion dedicated to search results for independent content items, the independent content item overview being located in the portion.

19. The method of claim 18, wherein the independent content items are ranked based on creator scores, where a creator score for a creator is based on quality scores for independent content items attributed to the creator.

20. The method of claim 19, wherein the ranking filters out independent content items that have a quality score that fails to meet a quality threshold.

21. The method of claim 17, wherein a format of the search result for the independent content item overview may be based on types of data attached to the independent content item.
